(19) United States
(12) Patent Application Publication
(10) Pub. No.: US 2023/0027773 A1
(43) Pub. Date: Jan. 26, 2023

(54) THERMALLY RELEASABLE FASTENING ELEMENT, IN PARTICULAR FOR FASTENING A DOOR ACTUATOR

(71) Applicant: dormakaba Deutschland GmbH, Ennepetal (DE)

(72) Inventor: Alexander HELLWIG, Ennepetal (DE)

(21) Appl. No.: 17/859,380

(22) Filed: Jul. 7, 2022

(30) Foreign Application Priority Data
Jul. 13, 2021 (EP) 21185319.7

(51) Int. Cl. F16B 31/00; E05F 7/00

(52) U.S. Cl. CPC F16B 31/007; E05F 7/00; E05Y 2600/46; E05Y 2600/51; E05Y 2600/632; E05Y 2800/252; E05Y 2900/132

(57) ABSTRACT

A thermally releasable fastening element, in particular for fastening a door actuator, includes a base body, which is designed to be inserted into a recess or a number of aligned recesses, a core inserted into the base body, at least partially made of a shape memory material, wherein the base body has an unstable area, which is stabilized by the core, and wherein the core is designed to withdraw at least partially from the unstable area upon thermal activation of the shape memory material.

### CROSS-REFERENCE TO RELATED APPLICATIONS

This application is related to and claims the benefit of European Patent Application No. 21185319.7, filed on Jul. 13, 2021, the contents of which are herein incorporated by reference in their entirety.

### TECHNICAL FIELD

The disclosure relates to a thermally releasable fastening element, which is used in particular for fastening a door actuator to a door.

### BACKGROUND

Door actuators are used to close and/or open doors. In particular, door closers and door drives are referred to as door actuators. In the case of door closers, a spring mechanism is usually charged by the manual opening movement. The energy stored in this way is used to close the door. With the door drive, for example, the door can be opened and/or closed independently by means of electromechanics or hydraulics. Door actuators are usually fastened on the door leaf or frame or wall.

In the case of fire protection doors in particular, it should be noted that flammable fluids, in particular hydraulic oils, are often used in the door actuators. Appropriate measures should be taken to prevent, as far as possible, the fluid from heating up too much in the event of a fire and potentially igniting it.

### SUMMARY

The present disclosure specifes a fastening element, which is released by thermal effects and thus, for example, allows a door actuator to fall off a door in the event of a fire.

The advantages are achieved by providing the features of the independent claim. The dependent claims have advantageous configurations of the disclosure as their subject matter.

The disclosure describes a thermally releasable element, which is used in particular for fastening a door actuator.

The fastening element comprises a base body, which is designed to be inserted into a recess or a plurality of aligned recesses. In particular, the base body is designed as a screw with a corresponding external thread or as an expansion dowel.

In addition to the base body, the fastening element has a core that is inserted into the base body. The base body extends in particular along its central axis, wherein, in the used state, this central axis in particular aligns with the axial directions of the recesses, into which the fastening element is inserted. In particular, the core used in the base body also extends along the central axis.

The core is at least partially made of a shape memory material. The entire core particularly preferably comprises the shape memory material. In particular, the core is partially or completely formed from a wire made of the shape memory material. The shape memory material is in particular a shape memory metal. The shape memory material is in particular a special metal, which can exist in two different crystal structures (e.g. austenite and martensite). The base body has an unstable area which is stabilized by the core. For this purpose, the base body can be designed in one piece, so that the unstable area is an integral part of the entire base body. The unstable area is preferably designed such that, without being stabilized by the core, it collapses inwards, i.e. towards the central axis. In order to stabilize the unstable area, the core preferably protrudes into the unstable area.

The core is designed and arranged such that, upon thermal activation of the shape memory material, it at least partially withdraws from the stable region. This thermal activation is equivalent to heating the shape memory material. The shape memory material (particularly the entire core) is preferably designed such that, during thermal activation, it shortens in its length defined along the central axis and thereby withdraws from the unstable area.

The thermal activation takes place in particular in a temperature range from 90° C. to 200° C.

Provision is preferably made for the unstable area to have at least one slot. The slot preferably extends parallel to the central axis and/or preferably to an end face of the base body. In particular, it is provided that the base body has a cylindrical shape. Inside the cylindrical shape is a hollow channel along the central axis for receiving the core. The at least one slot preferably extends in the radial direction from the surface of the unstable area into the hollow channel or up to the core.

In a particularly preferred embodiment, it is provided that the unstable area has a plurality of the slots and is divided into a plurality of segments by the slots. Due to this plurality of segments, a slight collapse or a slight caving-in of the unstable area radially inwards is possible, as soon as the core has at least partially withdrawn from the stable area.

The stable area is preferably located at one end of the base body. In particular, a head of the base body is located at the opposite end.

In a preferred embodiment it is provided that the core, in particular the shape memory material, extends over at least 50%, preferably at least 75%, of an axial length of base body. As a result, the core is designed to be relatively long and can undergo a correspondingly large change in length (shortening) during thermal activation.

As mentioned at the beginning, the base body is preferably designed as a screw with a corresponding external thread. The external thread is preferably located at least in the unstable area. The remaining area of the base body can also have the external thread. To use the fastening element, it is inserted into the element to be fastened (e.g. door actuator) and screwed into the associated mounting surface (e.g. door leaf). In the element to be fastened, the fastening element can be inserted in a through-hole without an internal thread, whereas the recess in the mounting surface has an internal thread. In this state, the core is inside the base body and protrudes into the unstable area to stabilize the unstable area. With corresponding thermal activation, i.e. when the core is heated, it contracts due to the shape memory material and thus pulls itself out of the unstable area. For this purpose it is particularly advantageous if the end of the core facing away from the unstable area is firmly connected to the base body. For this purpose, the core is welded or otherwise firmly connected to the base body, for example in the area of the head.

In a further variant, it is provided that the base body is designed as an expansion dowel. At its end facing away from the head, this expansion dowel has in particular a plurality of segments divided by slots. These segments, divided by slots, form, as already described, preferably the unstable area. When mounting the fastening element designed as an expansion dowel, the core does not initially extend into the unstable area, so that the fastening element can be easily inserted into the at least one recess. After insertion, the core is driven into the expansion dowel and thereby presses the unstable area radially outwards, so that this area wedges itself within the recess. If thermal activation occurs, the core again withdraws from the unstable area, allowing the unstable area to collapse radially inward.

In the case of the design as an expansion dowel, it is preferably provided that the core is designed to be firmly connected to the base body at the end of the base body facing away from the unstable area. In particular, it is provided for this purpose that a press fit is formed between the core and the base body in this area of the base body, so that after the core (expanding mandrel) has been driven in completely, the core is frictionally connected to the base body. However, in another manner, for example, by deformation of the core when it is driven in, a force-fitting and/or a form-fitting connection between the core and the base body can also be achieved.

When the base body is configured as an expanding mandrel, it is preferably provided that the unstable area has at least one form-fitting lug on its front end. In particular, these form-fitting lugs are located on the front ends of the segments described. When using the fastening element, these form-fitting lugs can be used for the form-fitting connection with the mounting surface or the element to be fastened.

The disclosure also comprises a door actuator assembly. This door actuator assembly in turn comprises a door actuator and at least one of the fastening elements described, which is designed for fastening the door actuator. It is also provided that door actuators can be fastened to mounting plates, wherein the mounting plate in turn is fastened to the door, in particular to the door leaf. The fastening elements described here can be used both to fasten the mounting plate to the door and to fasten the door actuator to the mounting plate.

The disclosure also comprises a door assembly. The door assembly comprises a door and the door actuator assembly described, i.e. the combination of door actuator and fastening element. The door actuator is fastened to the door, in particular to the door leaf, by means of the at least one fastening element. This describes both the variant with and without a mounting plate and thus the use of the fastening element for fastening the mounting plate to the door and the use of the fastening element for fastening the door actuator to the mounting plate.

The configurations and associated dependent claims described within the scope of the fastening element according to the disclosure are correspondingly advantageously used for the door actuator assembly according to the disclosure and the door assembly according to the disclosure.

### BRIEF DESCRIPTION OF THE DRAWINGS

The disclosure will now be described further on the basis of two exemplary embodiments, in which is shown:

FIG. 1 a door assembly according to the disclosure with a door actuator assembly according to the disclosure and fastening elements according to the disclosure in accordance with all exemplary embodiments.

FIGS. 2 and 3 the fastening element according to the disclosure before thermal activation in accordance with a first exemplary embodiment,

FIGS. 4 and 5 the fastening element according to the disclosure after a thermal activation in accordance with the first exemplary embodiment,

FIG. 6 the fastening element according to the disclosure in different states in accordance with a second exemplary embodiment, and

FIG. 7 the detail VII marked in FIG. 6.

### DETAILED DESCRIPTION OF THE DRAWINGS

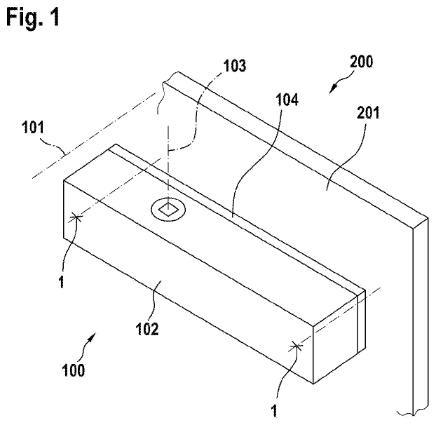

FIG. 1 shows a door assembly 200 for all exemplary embodiments. The door assembly 200 comprises a door 201, of which the door leaf is shown schematically. This door 201 forms a mounting surface with the associated mounting axis 101. FIG. 1 also shows a door actuator assembly 100. The door actuator assembly 100 comprises a door actuator 102, an optional mounting plate 104 and fastening elements 1.

The door actuator 102 has an output shaft 103, shown purely schematically. The door actuator 102 is connected to the frame or wall in the usual manner via this output shaft 103 and an associated linkage. The linkage can be designed here as a scissor linkage or slide rail linkage.

FIG. 1 shows purely schematically a plurality of fastening elements 1, which extend parallel to the mounting axis 101 and are used to fasten the door actuator 102 to the door 201. It is provided that the fastening elements 1 are used either to fasten the door actuator 102 to its mounting plate 104 and/or to fasten the mounting plate 104 to the door 201.

In the exemplary embodiments now presented, the same reference numerals are always used for identical or functionally identical components.

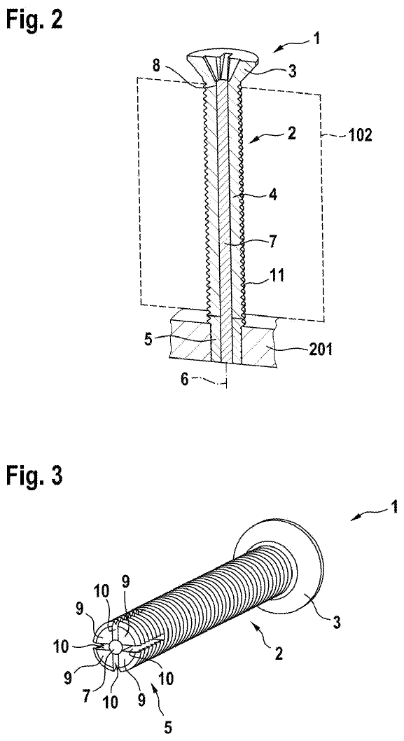

FIG. 2 shows a sectional view of the fastening element 1 in accordance with the first exemplary embodiment. An associated perspective view is shown in FIG. 3. For orientation, the door actuator 102 and the door 201 are shown purely schematically in FIG. 2.

The fastening element 1 comprises a base body 2 and a core 7. The base body 2 extends from a head 3 via a central area 4 to an unstable area 5 along its central axis 6.

The base body 2 has an external thread 11 on the central area 4 and on the unstable area 5 and is therefore designed as a screw.

The unstable area 5 is divided into four segments 9 by four slots 10. Each slot 10 extends parallel to the central axis 6 to the front end of the unstable area 5. Furthermore, the slot 10 extends in the radial direction from the lateral surface of the unstable area 5 to the core 7.

The core 7 extends substantially over the entire length of the base body 2, inside the base body 2 coaxial to the central axis 6. The core 7 protrudes into the unstable area 5 and thereby stabilizes the unstable area 5, so that the segments 9 cannot collapse radially inwards.

In the area of the head 3, the core 7 is firmly connected, in particular welded, to the base body 2 at a fastening area 8.

In the embodiment shown, the core 7 is formed entirely of a shape memory material, in particular a metallic wire.

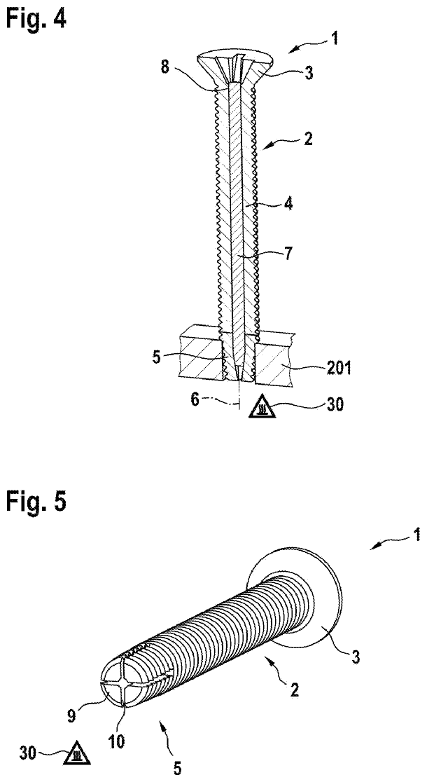

FIGS. 4 and 5 schematically illustrate a thermal activation 30. As a result of this thermal activation 30, the core 7 shortens its length and as a result withdraws from the unstable region 5. The unstable area 5 can collapse inwards. As a result, in the unstable area 5, the external thread 11 releases from the associated internal thread in the door 201, allowing the door actuator 102 to fall off the door 201. This prevents the door actuator 102 and in particular the hydraulic fluid in the door actuator 102 from heating up too much. It is of course to be understood that the door actuator 102 is on a side of the door 201 facing away from the fire and the thermal activation 30 is caused by a fire on the opposite side of the door 201.

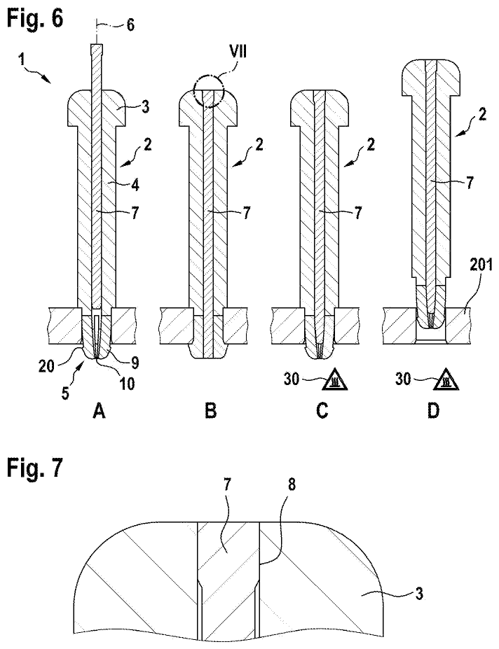

FIGS. 6 and 7 show the fastening element 1 in accordance with a second exemplary embodiment, in which the base body 1 is designed as an expansion dowel and the core 7 as an expanding mandrel. The core 7 is here again made entirely of the shape memory material.

FIG. 6 shows four different states A, B, C, D of the fastening element 1 in a sectional view. In state A, the core 7 has not yet been fully driven into the base body 2, whereby the unstable area 5 can collapse radially inwards. Again a plurality of segments 9 are provided here, which form the part of the expansion dowel to be expanded. Optional form-fitting lugs 20 can be used here for a form-fitting connection with the door 201.

After inserting the fastening element 1 according to state A, the core 7 is driven into the base body 2 according to state B and thus also extends into the unstable area 5, whereby the unstable area 5 is stabilized. This results in the unstable area 5 being clamped in the door 201 and at the same time in a form-fitting connection by means of the form-fitting lugs 20.

State C shows the thermal activation 30, in which the core 7 again withdraws from the unstable area 5, whereby the unstable area 5 can collapse and as a result the fastening element 7 can easily be released from the door 201. This in turn causes the door actuator 102 to fall off the door 201.

FIG. 7 shows the detail VII marked in FIG. 6. This detailed illustration shows that, in the area of the head 3 of the base body 2 in the fastening area 8, a press fit is formed between the core 7 and the base body 2. As soon as the core 7 has been driven into this fastening area 8, a force-fitting connection is created between the base body 2 and the core 7 in the fastening area 8, so that the core 7 is firmly connected to the base body 2 here.

It is to be understood that the fastening element 1 in accordance with both exemplary embodiments can also be used in other applications, in particular if an element to be fastened has to be released from its mounting surface in the event of fire.

1. A thermally releasable fastening element for fastening a door actuator, the fastening element comprising:
a base body configured to be inserted into a recess or a plurality of aligned recesses,
a core inserted into the base body, at least partially made of a shape memory material,
wherein the base body has an unstable area, which is stabilized by the core,
and wherein the core is designed to withdraw at least partially from the unstable area upon thermal activation of the shape memory material.

2. The fastening element according to claim 1, wherein the unstable area has at least one slot.

3. The fastening element according to claim 2, wherein the unstable area is divided into a plurality of segments by a plurality of slots.

4. The fastening element according to claim 1, wherein the unstable area is formed at one end of the base body.

5. The fastening element according to claim 1, wherein the core, extends over at least 50%, of an axial length of base body.

6. The fastening element according to claim 1, wherein the core is fixedly connected to the base body at an end facing away from the unstable region or is designed for fixed connection to the base body.

7. The fastening element according to claim 1, wherein the base body is designed as a screw with an external thread at least in the unstable area.

8. The fastening element according to claim 1, wherein the base body is designed as an expansion dowel and the core as an expanding mandrel.

9. A door actuator assembly comprising a door actuator and at least one fastening element according to claim 1 for fastening the door actuator.

10. A door assembly, comprising a door and a door actuator assembly according to claim 9, wherein the door actuator is fastened to the door with the at least one fastening element.
